(19) United States
(12) Patent Application Publication
(10) Pub. No.: US 2025/0100855 A1
(43) Pub. Date: Mar. 27, 2025

(54) VARIABLE HEIGHT TELESCOPING AND INDEXED FIXTURING SYSTEM

(71) Applicant: RDI (ROBAINA DESIGN INNOVATIONS) LLC, Newport Beach, CA (US)

(72) Inventors: Roberto E. Robaina, Cerritos, CA (US); Nicholas A. Elliott, Cerritos, CA (US)

(21) Appl. No.: 18/892,388

(22) Filed: Sep. 21, 2024

Related U.S. Application Data
(60) Provisional application No. 63/584,451, filed on Sep. 21, 2023.

(51) Int. Cl. B66F 1/06

(52) U.S. Cl. CPC B66F 1/06; B66F 2700/12

(57) ABSTRACT

A variable height fixturing system is provided. The system includes a base having a top base end and an opposing bottom base end; an aperture located within the top base end having an outer and inner aperture walls; a telescoping piston having axial cutouts along an external piston wall and capable of axial relative movement within the aperture, where the aperture configured to restrict the piston to sliding axially up and down; a rotating lock collar having one or more mating extrusions, where the one or more mating extrusions are configured to be received in the one or more external relief cutouts of the collar capture section; and a handle connected to the rotating lock collar. The base includes a collar capture section having one or more external relief cutouts; a connecting mechanism; and a main base body integrally connected between the collar capture area and the connecting mechanism.

### PRIORITY CLAIM

This application claims priority to U.S. Provisional Application No. 63/584,451 entitled “Variable Height Telescoping and Indexed Fixturing System” filed Sep. 21, 2023, which is incorporated by reference herein in its entirety.

### FIELD

Various aspects of the present disclosure pertain to jig and fixturing components and variable height fixturing systems.

### BACKGROUND

Variable height fixturing systems, often referred to as adjustable height fixturing systems, are tools or setups used in manufacturing, assembly, and testing processes to hold and position workpieces in a way that allows for flexibility in adjusting the height and orientation of the workpiece. These systems are designed to provide stability, precision, and adaptability, enabling efficient and accurate work on components of various sizes and shapes.

A workpiece is a term commonly used in manufacturing, machining, and engineering contexts to refer to a raw material or a semi-finished component that is being processed, modified, or worked on to create a finished product. It is the starting material on which various manufacturing operations are performed to achieve the desired shape, dimensions, surface finish, and functional properties.

Jig and fixturing systems are used in many industries for a variety of applications, in order to precisely and securely locate an object in space relative to a defined datum plane or set of known coordinates. Such applications include a means of holding and fixing components during manufacturing, testing, and/or repair. Jig and fixturing systems may be utilized while joining assemblies via welding, bonding, or fastening, or for inspecting for dimensional accuracy. These systems may be used by the original manufacturer to create a part, and/or by repair facilities as diagnostic, repair, and/or restoration guides and tools.

Many fixtures are single use applications. These fixtures are designed to be used for one unique application and may be used repeatedly as needed for that application. However, while these fixtures are great for long run production, they can easily become obsolete if the workpiece that requires a fixture change or falls out of production. This type of fixture is often a single component, may be big and bulky, and requires little to no setup or adjustments by the end user.

Other existing fixturing systems may employ universal fixturing components that can be manipulated to accomplish multiple tasks determined by different setups, such as a variable height fixturing system. Variable height fixturing systems may require unique attachments and/or jigs to interact with different workpieces, and can be set to a multitude of heights, allowing for a single fixturing system to accomplish many different tasks at different times. This type of variable height fixturing system requires a more skilled operator to setup but takes up far less storage space when multiple fixture setups may be required or fixture setups are continuously changing, such as in short run or one-off type fixture setups. However, to be truly universal and to meet all possible positioning requirements, this type of fixturing system often requires a large inventory comprising a multitude of components where only a select few may be used at any given time.

In the automotive repair bench industry, a variable height fixture will often capture a unique jig head piece that fits the top of a piston and must be precisely located to mate with a specific geometry of an automobile to be measured. A fixturing system may comprise many of these variable height fixtures, all with unique jig head pieces and at specific heights and X-Y positions, such that an automobile may be assessed for damage, alignment, repair, part installation or verification of accuracy, at a multitude of locations. Within certain fixturing systems, it is possible to use the fixtures to also measure the extent of certain damaged areas. In short, each fixture may locate a jig, and each jig is designed to locate and interact with a specific point on the target structure in order to verify whether that location is accurate or needs realignment.

One such fixturing system is comprised of a base with a fixed receiving tube perched at a known original height, which in turn receives and locks to a piston with a set of lock pins and matching through hole apertures. Both the piston and receiving tube may have several apertures to allow for multiple variations of arrangements. Thus, the top of the piston can be fixed to a limited set of known heights by adjusting which aperture locations the lock pins fit through. Also, pistons of differing lengths and bases with differing original heights may be employed to get a larger variation of arrangements.

These types of fixturing systems may be considered indexing systems because the achievable heights reached by the top of the piston for any specific base and piston combination is determined by the location of the apertures, and the variation of the heights are achievable due to the height differential between holes. These systems are accurate and strong but are digital in nature, limited to only the fixed operating positions allowed for within the designed combination of components. Thus, this type of system is great for go/no go positioning but difficult to use for measuring when a position is outside of the standard positions.

Other jig systems may be seen as more analog in nature in that pistons can be extended upward and locked to any number of locations within the range of the assembly. These systems again use a base and piston, but typically lock the two together with a threaded nut and/or a radial pinching or collet closing type system. Such a system may use measurements marked along the piston to tell a user what location to advance the system to in order to achieve the required height for any specific fixture.

These systems have the advantage of allowing the user to more easily measure when an area is damaged or outside the expected go/no go position. However, the accuracy of these systems heavily rely on the end user's ability to properly set up each fixture, and the strength of the locking collar is not as robust as the pinned system, leading to more damaged jig systems in practice. This is often a slower process as well due to the threaded connection and skilled setup.

In both these legacy systems described, a fixture base is attached to a table or table crossmember often by four threaded bolts per crossmember and four per fixture base. When placement adjustments are required, multiple threaded members then have to be removed and reinserted at the new location. This process takes time and can lead to lost or damaged components. Other workholding fixtures and jigs may attach via dovetail connections or t-slots with threaded members to lock the jig in place. The present disclosure eliminates the need for the user to engage with multiple threaded components and allows for the fixture base to attach to a table or bench with a single turn system that locks directly to the base table.

Thus, the industry lacks a variable height fixturing system that is simultaneously easy and fast to setup, predictable and repeatable when employed, strong enough to avoid damage in use, yet allows for precision measurements when needed, all while greatly reducing the number of components to accomplish the full range of setups required, and suitable for semi or full automation applications. Such a novel system is defined herein.

### SUMMARY

The following presents a simplified summary of one or more implementations in order to provide a basic understanding of some implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

According to one aspect, a variable height telescoping and indexed fixturing system is provided. The fixturing system includes a base having a top base end and an opposing bottom base end an aperture located within the top base end having an outer aperture wall and an inner aperture wall; a telescoping piston having one or more axial cutouts along an external piston wall and capable of axial relative movement within the aperture, where the aperture configured to restrict the piston to sliding axially up and down; a rotating lock collar having one or more mating extrusions, where the one or more mating extrusions are configured to be received in the one or more external relief cutouts of the collar capture section; and a handle connected to the rotating lock collar. The base includes a collar capture section having one or more external relief cutouts; a connecting mechanism; and a main base body integrally connected between the collar capture area and the connecting mechanism.

According to one feature, the inner aperture wall includes one or more material extrusions extending outward; and wherein the one or more material extrusions are adapted to be received in the one or more axial cutouts of the piston preventing rotation of the piston.

According to another feature, the variable height telescoping and indexed fixturing system further includes a fixture table, having one or more cutout tracks, forms a datum plane.

According to yet another feature, the base is slideably secured in a cutout track in the one or more cutout tracks, and where the base slides parallel to the fixture table.

According to yet another feature, the connecting mechanism comprises an upper portion integrally connected to a lower portion, where the lower portion is secured in the cutout track of the one or more cutout tracks.

According to yet another feature, further includes one or more extending locks are located in the lower portion of the connecting mechanism and configured to engage with the fixture table below the datum plane.

According to yet another feature, further comprising a digital display located within the base for displaying a height of the telescoping piston from the datum plane.

According to yet another feature, the base and the piston are capable of axial relative movement.

According to yet another feature, further includes a single turn locking mechanism for engaging four expanding lock pins and four location lock pins between base and fixture table.

According to another aspect, a variable height telescoping and indexed fixturing system is provided. The fixturing system includes a base having a top base end and an opposing bottom base end an aperture located within the top base end having an outer aperture wall and an inner aperture wall; a telescoping piston having one or more axial cutouts along an external piston wall and capable of axial relative movement within the aperture, where the aperture configured to restrict the piston to sliding axially up and down; a rotating lock collar having one or more mating extrusions, where the one or more mating extrusions are configured to be received in the one or more external relief cutouts of the collar capture section; and a handle connected to the rotating lock collar. The base includes a collar capture section having one or more external relief cutouts; a connecting mechanism; and a main base body integrally connected between the collar capture area and the connecting mechanism. The connecting mechanism includes an upper portion integrally connected to a lower portion, where the lower portion is secured in the cutout track of the one or more cutout tracks.

### BRIEF DESCRIPTION OF DRAWINGS

Various features, nature and advantages may become apparent from the detailed description set forth below when taken in conjunction with the drawings in which like reference characters identify correspondingly throughout.

FIG. 1 illustrates a typical prior art variable height fixture.

FIG. 2 illustrates another typical prior art variable height fixture.

FIG. 3A illustrates a variable height telescoping and indexing fixture in a fully open position, according to one aspect of the present disclosure.

FIG. 3B illustrates the variable height telescoping and indexing fixture of FIG. 3A in a fully closed position.

FIG. 4A illustrates a base component of the variable height telescoping and indexing fixture, according to one aspect of the present disclosure.

FIG. 4B illustrates an operating mechanism for attaching the base component of the variable height telescoping and indexing fixture to a workbench, according to one aspect of the present disclosure.

FIG. 5 illustrates a piston component of the variable height telescoping and indexing fixture, according to one aspect of the present disclosure.

FIG. 6 illustrates a rotating lock collar component of the variable height telescoping and indexing fixture, according to one aspect of the present disclosure.

FIG. 7A illustrates a base, piston, and rotating lock collar of the variable height telescoping and indexing fixture of the present disclosure with the rotating lock collar in the engaged and locked position.

FIGS. 7B through 7D illustrate a base, piston and rotating lock collar that progress through the disengaged positions and allow for the piston to slide, according to one aspect of the present disclosure.

FIGS. 8A and 8B illustrate a variable height telescoping and indexing fixture, according to another aspect of the present disclosure.

FIG. 9 illustrates a piston and head component jig of the variable height telescoping and indexing fixture according to one aspect of the present disclosure.

FIG. 10A illustrates a table of available height positions for an aspect of this design in one instance of variable indexed spacing between pistons.

FIG. 10B illustrates a variable height telescoping and indexing fixture in a fully open position and a fully closed position.

FIG. 11 illustrates a variable height telescoping and indexing fixture engaged with and locked into a set of rails.

FIG. 12 illustrates a side view of a set of variable height telescoping and indexing fixtures locked into a set of rails and employed at different heights.

FIG. 13A illustrates a top view of a car bench setup layout with jigs attached to the system of the present disclosure.

FIG. 13B illustrates a side view of the car on the setup shown in FIG. 13A.

FIG. 14A shows a side view of a unique pipe which can be fixed to, or rest on, a matching bench setup of the system of the present disclosure.

FIG. 14B shows a top view of a unique pipe which can be fixed to, or rest on, a matching bench setup of the system of the present disclosure.

FIG. 14C shows a perspective view of a unique pipe which can be fixed to, or rest on, a matching bench setup of the system of the present disclosure.

### DETAILED DESCRIPTION

The novel characteristic features of this disclosure are set forth in the appended claims. The detailed description of disclosure along with mode of operation and its organization, advantages and additional objects are presented here, along with applicable drawings, for better understanding. Descriptions of specific aspects are best understood when read in connection with these drawings.

In the following description numerous specific details are set forth in order to provide a thorough understanding of the disclosure. However, one skilled in the art would recognize that the disclosure might be practiced without these specific details. In other instances, well known methods, procedures, and/or components have not been described in detail, so as not to unnecessarily obscure aspects of the disclosure.

While the present disclosure is described primarily with respect to telescoping and indexed variable height fixturing systems for subframes and components in the automotive industry, the present disclosure may be applied and adapted to various applications. The present disclosure may be applied to other components in any industry where indexed telescoping pistons and/or fixtures may be beneficial in holding and fixing components during manufacturing, measuring, inspection, testing and or repair. Also, a variety of other aspects are contemplated having different combinations of the below described features of the present disclosure, having features other than those described herein, or even lacking one or more of those features. As such, it is understood that the present disclosure can be carried out in various other suitable modes.

According to aspects of the present disclosure, a variable height fixturing system that is simultaneously easy and fast to setup is disclosed. This variable height fixturing system is predictable and repeatable when employed, strong enough to avoid damage in use, yet allows for precision measurements when needed, all while greatly reducing the number of components to accomplish the full range of setups required, and suitable for semi or full automation applications, is defined below. This system features novel designs, in geometry and functionality, as described in detail below.

### Existing Fixture Designs (Prior Art)

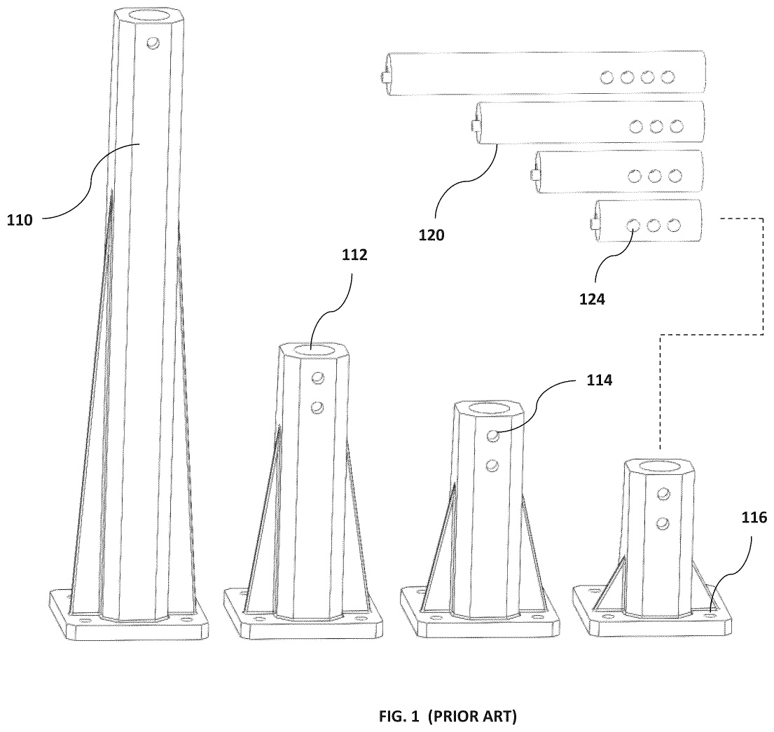

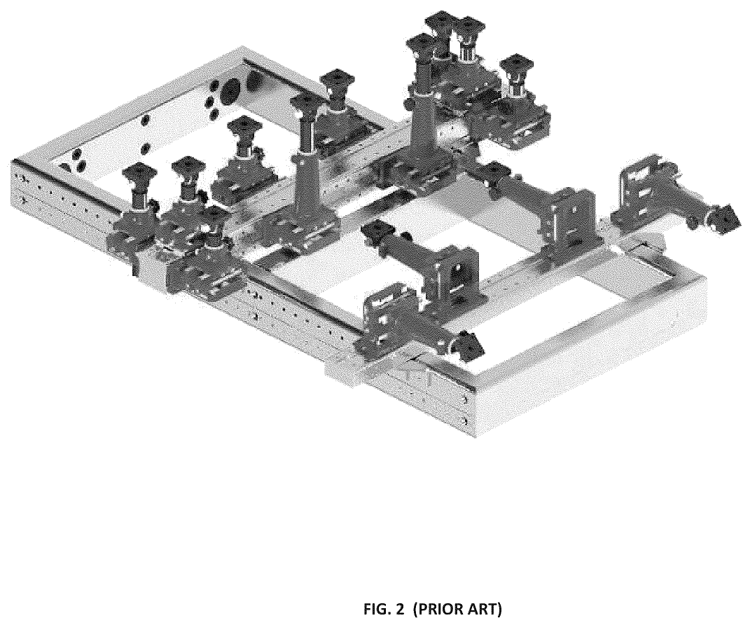

FIG. 1 illustrates a typical prior art variable height fixture used within the automotive repair industry. As shown, the variable height fixture is comprised of a set of bases 110 and pistons 120. Each base 110 contains a piston capture aperture 112 one or more pin placement apertures 114, and multiple assembly placement apertures 116, often four, for mounting to a crossmember component (not shown) and in turn to a base table (not shown). Each piston 120 has one or more pin apertures 124 such that when the piston 120 is placed within the base 110 at the piston capture aperture 112 and at the desired height location, one of the piston pin apertures 124 should align with one of the base pin placement apertures 114 such that a locking pin can be inserted fully through the two components. In this position, the piston 120 is locked in relation to the base 110, with no freedom of movement (other than slop within a tolerance error.) Due to the indexing nature, this fixture is typically considered easier to set-up for the end user as compared to other analog variable height fixtures, such as the variable height fixture shown in FIG. 2. However, as seen in FIG. 1, a multitude of components are required to achieve the range of heights desired by the industry, which could be reduced to one set of fixtures with the present disclosed design, as described in detail below.

FIG. 2 illustrates another typical prior art variable height fixture comprised of a base and piston. In this example, the piston is marked with a defined set of measurements and the base includes a collar section that radially squeezes the piston to hold it in the desired position. This is a weaker connection than the pinned version in FIG. 1, requires more time to set up, and more skill of the operator to generate an accurate setup. However, the fact that these parts include a measuring feature makes them useable to determine unknown locations when parts are damaged.

Note that in neither automotive repair legacy system, described in FIG. 1 or FIG. 2, does the fixturing assembly mount directly to the table. In both cases, a secondary crossmember is required, adding to the complexity of setup and number of components required.

### Novel Fixture Designs

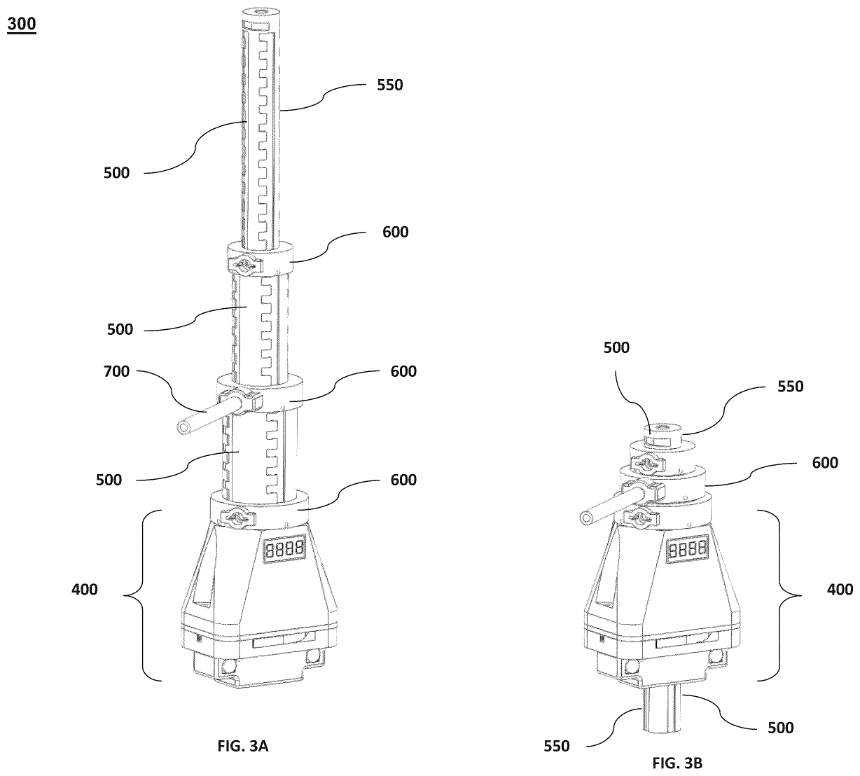

FIG. 3A illustrates a variable height telescoping and indexing fixture 300 in a fully open position and FIG. 3B illustrates the variable height telescoping and indexing fixture of FIG. 3A in a fully closed position, according to the present disclosure. As shown, the variable height telescoping and indexing fixture 300 comprises a base 400, indexing pistons 500, rotating lock collars 600, and a keyed handle 700. The piston and base may have corresponding geometry so as to prevent any relative rotation and restrict the freedom of movement of the piston to only axial relative movement. The corresponding geometry may include one or more axial relief cutout channels on the piston, and corresponding extrusions on the base, described in more detail below.

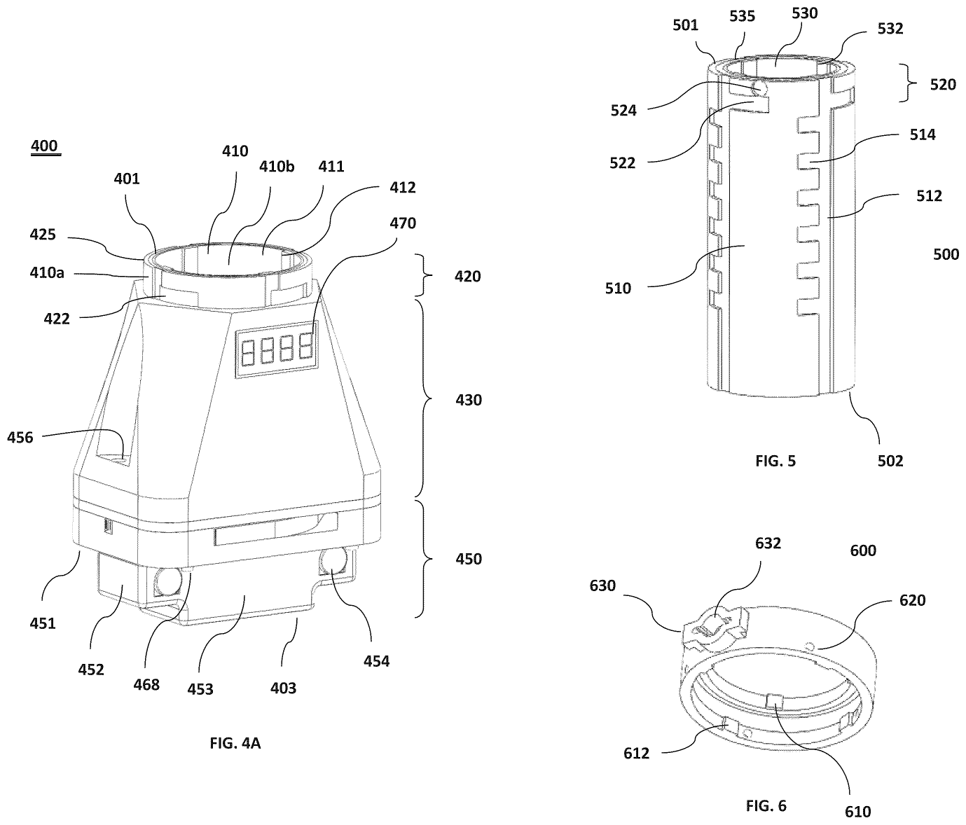

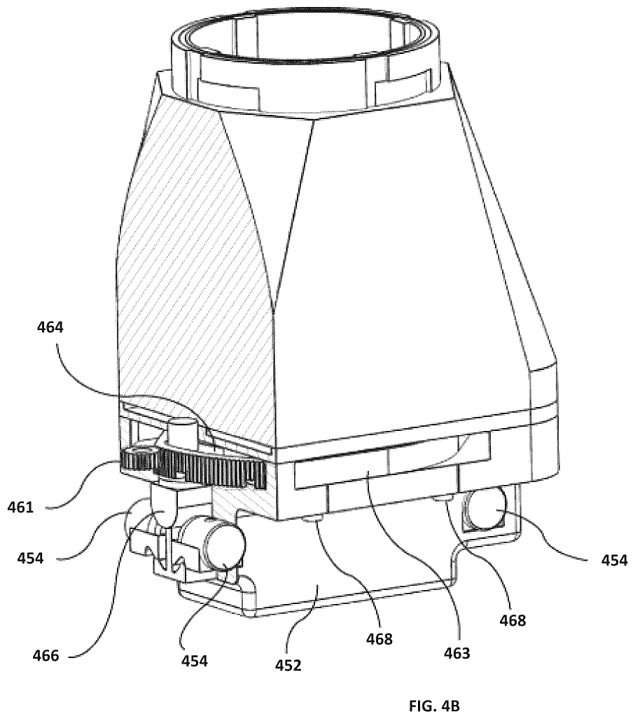

FIG. 4A illustrates a base component 400 of the variable height telescoping and indexing fixture, according to one aspect of the present disclosure. As shown, the base 400 is designed to encompass and retain the piston 500 from any rotational movement, provide a means of axially retaining a rotating lock collar 600 (i.e. axial relative movement) in place while still allowing it to rotate within a defined path, and allow to be fixed to a bench or other known datum plane.

To accomplish this, the base 400 includes a top base end 401 vertically connected to a collar capture section 420, a main base body 430, a connecting mechanism 450, and a bottom base end 403, and an aperture 410. The aperture 410 has an outer aperture wall 410a and an inner aperture wall 410b.

The aperture 410 is designed to encompass and allow for the piston 500 to slide axially up and down while limiting all other ranges of movement. Thus, to prevent piston rotation, aperture walls 411 (i.e. walls of the aperture 410) may include material extrusions 412 that extend outward toward the central axis to capture an axial cutout along the piston external wall. This material extrusion 412 may extend the entire axial length of the aperture wall 411 (from top base end 401 to bottom base end 403,) or it may only extend a portion of that length, starting at or near the top base end 401. The base may have relief cutouts to accept and house specific extrusions on the rotating collar such that in operation, the collar's freedom of movement is limited only to rotation, and only within a range defined by the relief cutouts on the base.

Externally, the base 400 has a defined collar capture section 420, designed to accept the rotating lock collar 600 while retaining its axial motion, but allowing for a defined rotational motion. This is accomplished via external radial relief collar cutouts 422 and channels that guide mating extrusions on the rotating lock collar 600. The collar capture section 420 may also include a race cutout 425 on the first top end 401. This race cutout 425 may house ball bearings in order to ease the rotational motion of the rotating lock collar 600.

Immediately adjacent to the collar capture section 420, a main base body 430 will provide any required height and strength desired by the end use of the design. Thus, in other aspects of this design, the height of the main base body 430 may be minimized to allow for lower clearance or maximized to achieve required heights. The main base body 430 is adjacent to the connecting mechanism 450 which enables the design to attach to a fixed datum, such as an automotive collision repair bench.

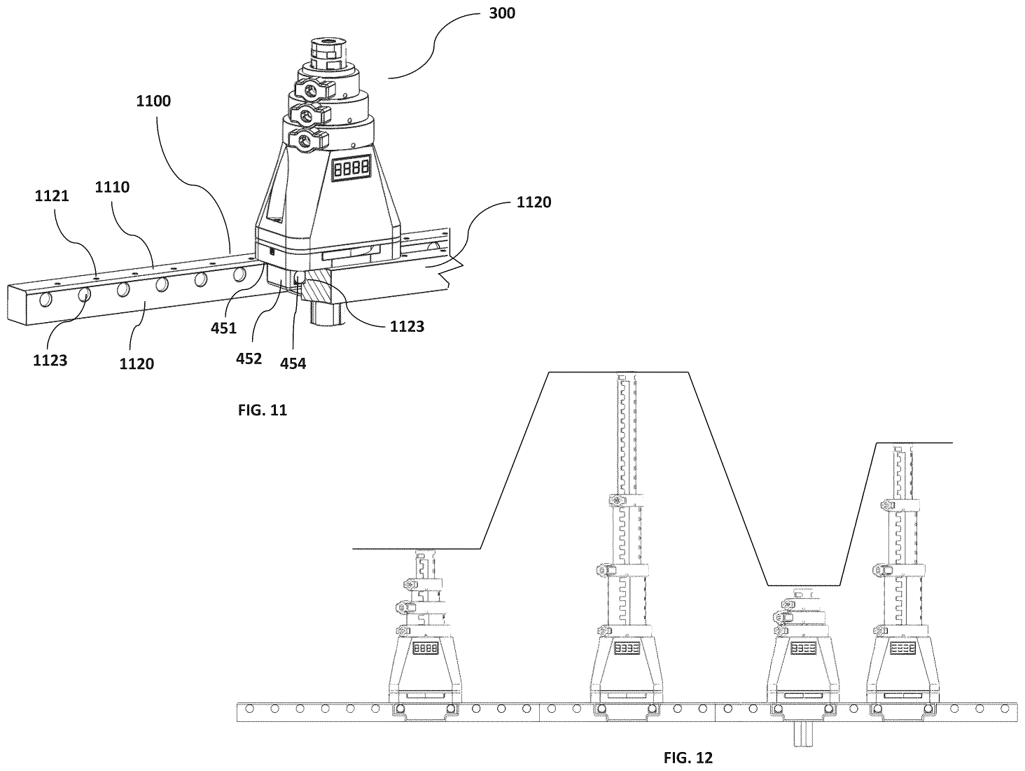

The connecting mechanism 450 can include a hole pattern to match existing legacy repair benches, welding tables, computer numerical control (CNC) machine benches, or any other currently in use fixed datum plane. However, the preferred aspect of the variable height telescoping and indexing fixture 300 includes the connecting mechanism 450 comprising an upper portion (or face) 451 integrally connected to a lower portion 452. The connecting mechanism 450 interacts with a top portion of a unique fixture table acting as the datum plane such that the lower portion (or protrusion) 452 sits within a cutout track such that the protrusion 452 may slide with the unique fixture table parallel to and along a front surface 453 of the protrusion. Four extending locks 454 located within the protrusion 452 may engage with specific geometry on the unique fixture table below the datum plane such that when the extending locks 454 are engaged, the base 400 is locked into and fixed to the unique fixture table. Four extending locks is by way of example only and there may be more than four (4) extending locks or less than four (4) extending locks. These extending locks 454 may be extended and retracted through a series of gears, rack and pinions, levers, or any other mechanical, pneumatic, or hydraulic means known in the art, such that a single tool may operate all four (4) extending locks 454 simultaneously, with tool access shown at aperture 456. Such an engagement is shown in FIG. 11.

According to one aspect, a single turn locking mechanism for engaging four expanding lock pins and four location lock pins between base and fixture table may be utilized. The single turn locking mechanism engages the base to the fixture table for secure engagement, and wherein the signal turn locking mechanism lacks threaded components. In other words, the single turn locking mechanism does not include threaded components, i.e., nuts and bolts, for secure engagement.

As shown in FIG. 4B, the variable height telescoping and indexing fixture 300 utilizes a drive gear 461, connected to a large force transfer gear 463 which is centered on the radially smaller piston 550 (See FIG. 3B). The force transfer gear 463 has a series of tracks and ramps 464 which force two activation mechanisms 466 up and down, one on each side of the unit. Each activation mechanism 466 will force a pair of extending locks 454 outward, or pull the extending locks 454 inward, depending on the rotation of the drive gear 461. This action may also act to lock in a further set of four (4) location and lock pins 468 designed to enhance the engagement between the base 400 and the datum plane.

The unique connecting mechanism 450, combined with a unique fixture table, allows for an extended piston 550 (which is radially smaller than piston 500), such that when in the lowered most position, the radially smaller piston 550 may extend below the datum surface, and even below the second bottom end 403, when in the collapsed stage as shown in FIG. 3A. This is not feasible with legacy platforms as the datum surface will not allow for any part of the fixture, with the exception of fasteners, to extend below the surface. As a result, this extended radially smaller piston 550 (i.e., smaller than piston 500) allows for a larger vertical range and higher topmost position when extended and telescoped out. With this larger vertical range and higher topmost position, fewer components are required to accomplish the same range as legacy product systems, i.e., existing prior art systems.

Optionally, a digital display 470, such as a liquid crystal display, may be present on the base 400. The digital display 470 may be in electrical communication with measuring equipment in order to provide the user a reading of the height of the radially smaller piston 550 from the datum plane. The digital display 470 may also be linked via wired or wireless connections to a dashboard or other form of reporting software, such that the user can have a digital copy of the position and height of each piston within the system. This information may then be used to generate reports for a customer, for the user's records, or any other as needed reasons. Such a system allows the user to check the accuracy of the physical setup against an expected digital setup via software, create and save new setups, as well as provide a measuring system for unknown locations during prototyping, or damage assessment of points of interest potentially outside the expected values of a setup.

Turning to FIG. 5, a piston 500 of the variable height telescoping and indexing fixture 300 is shown, according to one aspect of the present disclosure. The piston 500 is designed to be able to slide axially within the base 400 and house and retain further smaller pistons such that multiple pistons act in a telescoping manner. The piston 500 is also designed to interact with the rotating lock collar 600 such that when the rotating lock collar 600 is engaged, the piston 500 is fixed with no freedom of motion relative to the base 400 and the rotating lock collar 600.

As shown, the piston 500 fits into the base 400 by having near matching geometries as the base aperture 410 and external vertical relief cutouts 512 which encompass the base material extrusions 412. In this manner, when the piston is housed by the base 400 and is only capable of axial relative movement.

Furthermore, the piston 500 is comprised of a first top face 501, and a second bottom face 502, which connect and define an external surface 510 and may include an aperture 530. The external surface 510 further comprises the aforementioned vertical relief cutouts 512 and multiple radial relief cutouts 514, as well as radial relief collar guide cutouts 522 and a collar lock depression 524 on a collar capture area 520 near the first top face 501.

The radial relief cutouts 514 are linked and directly adjacent to the vertical relief cutouts 512. These radial relief cutouts 514 are designed to engage with the upper lock teeth 610 of the rotating lock collar 600, such that when the rotating lock collar 600 is engaged, the piston 500 is restrained from axial movement as well as all other degrees of freedom, fixing the piston 500 into the desired position. The base 400 and piston 500 may be connected and locked axially in place through the rotating lock collar 600.

The radial relief collar guide cutouts 522 are inserted on the collar capture area 520, near the first top face 501, such that a secondary rotating lock collar 600 may be fixed axially to the piston 500 and allow for further pistons 500 to fit within, and telescope out, from one another. Thus, the radial relief collar guide cutouts 522 of the piston 500 and the radial relief collar cutouts 422 of the base 400 act in the same manner, with the only exception that each tier requires a rotating lock collar 600 that is appropriate in size.

Along the first top face 501, a race cutout 535 may accommodate ball bearings, as needed to aid in the radial movement of the collar.

As with the base 400, the piston 500 may have internal geometry including an aperture 530 and material extrusions 532 to house further telescoping pistons. However, the piston 550 (which is radially smaller than piston 500) within the telescoping series may be desired to be solid, as no further pistons are required to be housed within it.

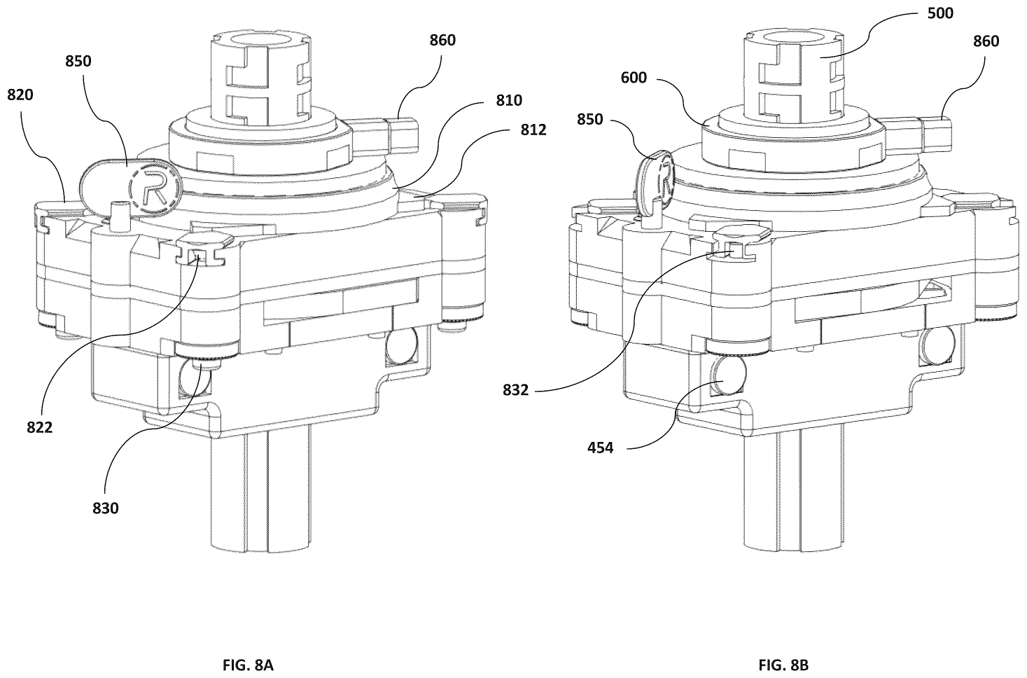

The radially smaller piston 550 within the telescoping series, which may be the only piston as seen in FIG. 8A and FIG. 8B, may also have unique features on or near the first top face 501, in order to capture the desired headpiece required by the jig setup. That is, when measuring or checking for location accuracy of a point on a car, the head piece is often unique to that location. Such a head piece would fit into and onto the unique features of the radially smaller piston 550 for final vertical placement within the setup. In another aspect, the initial piston 500 may be of a tubular shape with all required geometry to mate and slide over the radially smaller piston 550 which could extend and retract in a telescoping manner. In other words, the final piston may have means to connect to unique head pieces in a range of different orientations.

The piston may have radial relief cutouts, adjacent to the axial relief cutout channels, at specific locations to provide a method of indexing and locking the piston to the collar and in turn to the base. As with the original base and piston, smaller telescoping pistons may have all the necessary axial and radial relief cutouts on the external geometry, and all related extrusions within the internal sections to interact with corresponding pistons and locking collars.

The rotating lock collar 600 of FIG. 6 is designed to retain and fix the inner piston to the base or housing piston while engaged yet allow for axial movement of the same inner piston when rotated to a disengaged position. This action is accomplished by two sets of locking teeth, upper locking teeth 610 and lower locking teeth 612.

The upper locking teeth 610 impedes axial movement by interacting with the inner piston's radial relief cutouts 514 when engaged and allows axial movement by sliding within the vertical relief cutouts 512 when rotated to be disengaged.

The lower locking teeth 612 engage with either the base collar capture section 420 or housing piston collar capture area 520, depending on position within the system. When inserted and positioned into the corresponding radial relief collar cutouts 422 or 522, upper locking teeth 610 restrain the rotating lock collar 600 from axial movement, while still allowing for guided rotational movement.

The rotating lock collar 600 may also employ separate features to maintain operational securities such as safeguards designed to prevent unwanted movement or movement outside of the desired range. A threaded hole 630 is shown on the rotating lock collar 600 designed to accept a set screw or other threaded member, to act as a stop and prevent the collar from being able to be rotated to a position where the lower locking teeth 612 will align with the vertical relief cutouts 512 of the piston 500 in normal operating conditions. Further, a springed engagement lock 632 may exist in a keyed access portion 630 of the rotating lock collar 600. Such an engagement lock 632 could be designed to interact with the collar lock depression 524 to prevent unwanted rotating lock collar rotation and thus disengagement.

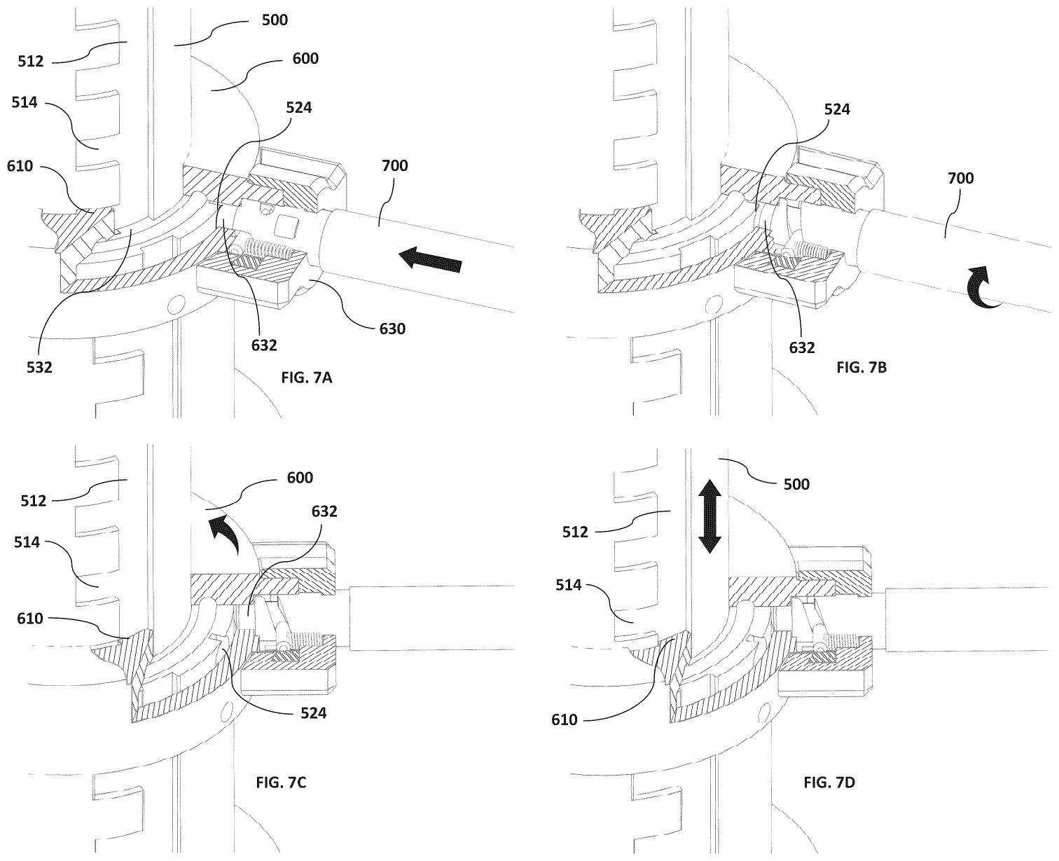

Engagement of the rotating lock collar 600 with the base and the piston 500 are illustrated in FIGS. 7A-7D. FIG. 7A illustrates a base, piston, and rotating lock collar of the variable height telescoping and indexing fixture of the present disclosure with the rotating lock collar in the engaged and locked position. FIGS. 7B through 7D illustrate a base, piston and rotating lock collar that progress through the disengaged positions and allow for the piston to slide, according to one aspect of the present disclosure.

As shown in FIG. 7A, the rotating lock collar 600 is in the engaged and locked position. The lower locking teeth 612 sit within the base radial relief collar cutouts 422, if adjacent to the base 400, or the radial relief collar cutouts 522 if attached to a piston 500. The upper locking teeth 610 sit within the piston radial relief cutouts 514, and the springed engagement lock 632 is affixed to the collar lock depression 524 of the piston 500.

In order to disengage the rotating lock collar 600 and allow for axial travel of the piston 500, a keyed handle 700 is inserted into the keyed access portion 630 of the rotating lock collar 600. When the keyed handle 700 is turned, as shown in FIG. 7B, the springed engagement lock 632 is retracted from the collar lock depression 524 and the rotating lock collar 600 is free to rotate, as seen in FIG. 7C. This rotation of the rotating lock collar 600 forces the upper teeth 610 out of the piston radial relief cutouts 514 and positions them into the vertical relief cutouts 512. Next, FIG. 7D illustrates the rotating lock collar 600 rotated and disengaged from the piston 500, allowing the piston 500 to slide axially to the desired location. Note that in FIGS. 7C and 7D the lower locking teeth 612 are still within the piston radial relief cutouts 514. It can also be noted that the designed interaction between the keyed handle 700 and the keyed access portion 630 of the rotating lock collar 600 can be designed such that the keyed handle 700 can only be twisted back to a neutral position and removed when the springed engagement lock 632 is in alignment with the collar lock depression 524. In this manner, the user can know that the setup cannot be used with the keyed handle 700 in place and that when the keyed handle 700 has been removed, the rotating lock collar 600 is properly engaged and secured in position with the springed engagement lock 632.

To properly adjust an assembled current variable height telescoping and indexing fixture 300, as depicted in FIG. 3A, each rotating lock collar 600 must be individually disengaged such that the corresponding piston 500 can be moved axially to the desired location. When all three pistons of the variable height telescoping and indexing fixture 300 are in place, the fixture 300 can be utilized by the end user.

The height achieved by the radially smaller piston 550 is determined by which radial relief cutouts 514 are utilized as well as the pattern spacing between those cutouts. Thus, the radial relief cutouts 514 are designed to have a patterned spacing such that each notch is a defined and countable differential difference in the final fixed position of the piston head. An example of this could be if each radial relief cutout 514 had a vertical pattern spacing of 0.75″ between cutouts. In this case, if someone wanted to raise or lower the position 3″ from its current placement, one would simply manipulate the fixture 300 to raise or lower a piston four (4) notches.

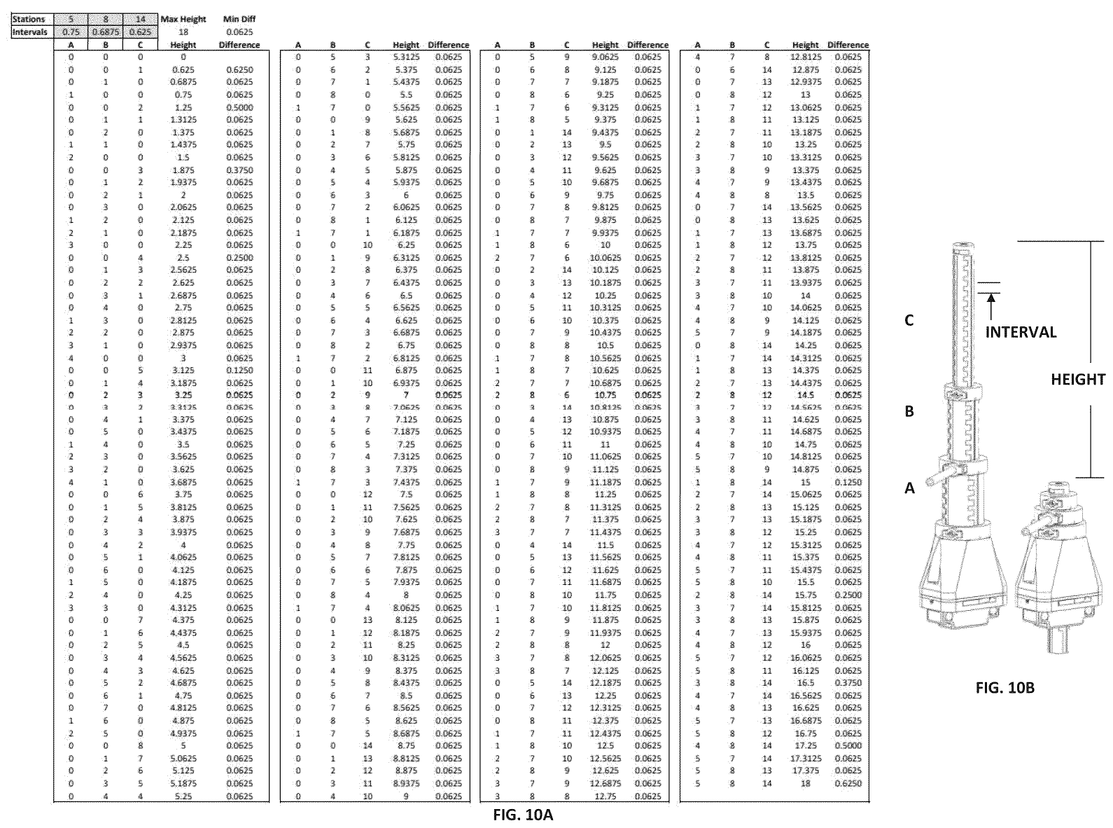

Furthermore, if all 3 pistons of the fixture 300 have the same pattern spacing between radial relief cutouts 514, then that pattern spacing, or period, is the only indexable unit. That is, the system can only move up or down by that unit of pattern spacing. However, it is also possible to differ the pattern spacing between pistons such that each piston has a unique pattern or period. In such a manner, the unique positions of the radially smaller piston 550 may be immensely increased. Such a system is shown in the table of FIG. 10A which depicts the largest piston with a spacing of 0.750″ (¾″), the second piston with a spacing of 0.6875″ (11/16″), and the radially smaller piston 550 with a spacing of 0.625″ (⅝″). Thus, the various unique positions are vastly increased such that almost every 1/16″ can be represented, and often in multiple ways, with the only exceptions being at the far extremes of the range. FIG. 10B illustrates a variable height telescoping and indexing fixture in a fully open position and a fully closed position.

### Engagement to a Datum Plane

Fixtures are often required to be positioned in a very specific location, and within a fixture system these fixtures are likely required to be in a specific position relative to other fixtures. This means that the fixture unit must have a means of locating itself and attaching itself to a datum plane. Most legacy systems utilize threaded bolts to pass through a hole pattern in the base and attach to threaded holes or nuts located within the structure of the datum plane utilized. This hole pattern can be seen as the multiple assembly placement apertures 116 in FIG. 1, and the fixtures can be seen attached to a datum plane in FIG. 2.

The connecting mechanism 450 designed within the base 400 is unique in that it fits below the datum plane. Thus, new hardware to act as an adaptor to existing benches, or a novel structure altogether, must be created, as seen in FIG. 11. Such a structure or fixture table would create the required top datum plane 1110 via guide rails 1120 on which face 451 of the base 400 may engage, as well as a gap to accept the protrusion 452. This gap should be no wider than the protrusion 452 and would interact with the sliding faces 453 but may be elongated in such a manner that the unit may slide within the gap. Location markings and location recesses 1121 may be present on the top datum plane 1110 such that the current design 300 may be precisely located on the fixture table 1100. The guide rails 1120 will also require an undercut and or recess cuts 1123 designed to accept the extending locks 454. These recess cuts 1123 may be indexed and found only at the desired location of unit placement or may run the entire length of the rail, depending on the application.

Thus, a multitude of fixtures 300 can interact with a set or multiple sets of guide rails 1120 to comprise of a unique fixturing system as seen in FIG. 12. Such a system can slide into place within the unique datum table, and fixtures can be reduced in size to fit under obstructions as needed. In this case, FIG. 12 shows a series of fixtures interacting with a workpiece with specific heights at specific locations. As seen, the same fixtures are employed in all locations but are utilized with differing height setup values.

### Additional Features and Alternate Aspects

As an alternate aspect, when only a limited range is required, the base 400 may be designed such that the height of the main base body 430 is minimized and adjusted to only require the radially smaller piston 550. Such an aspect is shown in FIG. 8A and FIG. 8B. In this aspect the fixture is more compact, but not capable of achieving the larger height ranges of the three-piston fixture previously described, limited to only the incremental heights of the radial relief cutouts 514 of the single radially smaller piston 550. The relief cutouts for indexing may be of differing variations on different pistons (i.e., the largest piston may have indexing heights of 0.750″, and the adjacent piston may have an indexing height of 0.500″), such that a larger variation of top piston positions may be reached.

Another feature which may benefit the user is the addition of lifting and sliding feet in order to ease the process of moving and positioning the variable height telescoping and indexing fixture 300 on the novel fixture table.

Such a feature, as seen in the alternate aspect shown in FIG. 8A and FIG. 8B, can aid in the disengagement of the base 400 and the novel fixture table by lifting the variable height telescoping and indexing fixture 300 vertically upwards as compared to the fixture table, and thus disengaging the location and lock pins 468 from their mating location recesses 1121 in the fixture table. The feet used to lift the variable height telescoping and indexing fixture 300 would interact with the fixture table away from any of the previously defined apertures and recess geometry of the fixture table and could fit into a recess or track specifically designed to accommodate the feet in the extended position. In said extended position, these feet could glide or roll along the top surface, or defined recess, of the fixture table until the variable height telescoping and indexing fixture 300 is positioned in the approximate location needed. At this time the user could retract the feet fully into the base 400, allowing for the lowering and proper positioning of the variable height telescoping and indexing fixture 300 for all intended operations previously described. In other words, the base may contain features that lift the fixture assembly off of the base table, when fully unlocked from the base table, such that the fixture assembly can be easily slid along the base table and maneuvered into the required setup position. That is, the base may contain certain features to lock and unlock a properly located fixture assembly to a base table, through the use of a single rotational movement.

One way to accomplish this extension and retraction of sliding feet is shown in FIGS. 8A and 8B. FIGS. 8A and 8B illustrate a variable height telescoping and indexing fixture, according to another aspect of the present disclosure.

In this aspect, the main base body 430 has been adapted to accept a rotational ring 810 with external radial cam features 812. These cam features 812 interact with and provide radially force to a force transfer tab 820 tracked to the main base body 430. As the force transfer tab 820 is forced outward, a ramp surface 822 on the underside of the force transfer tab 820 interacts with a lifting post 832 of the lifting feet 830, forcing the lifting feet to extend downward and outside of the main base body 430. When the cam feature 812 is reversed and the force transfer tab 820 is allowed to be retracted, the lifting feet 830 are allowed to retract back fully into the main base body. Thus, the extension and retraction of all four lifting feet 830 can be controlled simultaneously with the rotation of a single rotational ring 810.

Additional features to note in the alternate aspect of FIGS. 8A and 8B include the manual position locking tool 850 to engage the unit 300 to the fixture table, which extends the extending locks 454 with a simple rotational movement. Also note an alternate version of a collar 600 may be used such that a piston 500 may be unlocked by pulling a spring-loaded handle 860 radially outward, allowing the collar to unlock from the collar capture section 420 and rotate in such a way that the piston 500 is free to travel axially, as previously described.

It should be noted here that since the orientation of the unit is defined by the novel fixture table, it is possible that the fixture table is located in a vertical orientation, or even an inverted orientation, instead of the standard horizontal orientation typically shown. In this manner, the system described may provide fixturing locations in any manner of ways to better serve the end user.

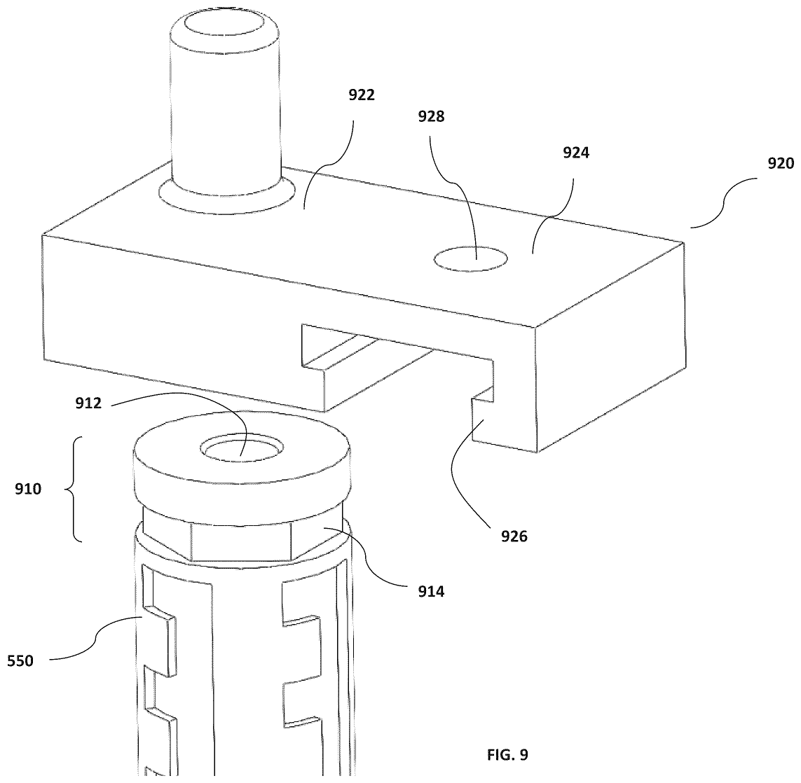

Other features may include a ratcheting lock mechanism between the rotating lock collars 600 and pistons 500 such that in this measurement roll, the rotating lock collar 600 could be disengaged so the piston could be moved freely to provide measurements, while a ratcheting lock mechanism would act to hold the piston in place as needed. With the reading secure, the variable height telescoping and indexing fixture 300 may be set up to the desired height based on a chart such as displayed in FIG. 9 with all collars properly engaged.

Next, as a function of the design, unique head components are intended to attach to the top of the radially smaller piston 550. This may occur in a multitude of ways and can be currently shown to have many ways of orienting the head component. One such manner is shown in FIG. 9, with the radially smaller piston 550 having a jig head capture area 910 at and adjacent to the first top face 501. This jig head capture area 910 may include a capture hole 912, which may or may not be threaded, on the first top face 501 and sets of parallel reception cuts 914, along the exterior and near the first top face 501, which are deep enough to provide a set of rails 916. These reception cuts 914 are currently shown and described as a hex cut but may be any number of designs, including a single set or any multitude of sets.

The jig head capture area 910 can mate with the specific geometry of a head component jig 920, such that the head component jig 920 slides into the reception cuts 914, mating and orienting with one of the parallel sets of reception cuts 914. The head component jig 920 may then be locked in place utilizing the capture hole 912, such that a threaded member locks the head component jig 920 to the top surface 501 of the radially smaller piston 550, or a springed capture pin engages with both the head component jig 920 and the radially smaller piston 550 via the capture hole 912. In this manner a head component jig 920 is fixed to the radially smaller piston 550, restricted from movement in x, y, and z planes as well from rotational movement.

Thus, a head component jig 920 capable of mating with the jig head capture area 910 may also require certain geometry, composed of a jig portion 922 and an engagement portion 924. The jig portion 922 can be any unique geometry designed to interact with a desired workpiece and will not be described further here. The engagement portion 924 may include a parallel set of mating rails 926, to engage and interact with the jig reception cuts 914, and an engagement aperture 928, such that a threaded member may pass through to lock into the capture hole 912 or engage with springed capture pin

In this case these reception cuts 914 provide three parallel surfaces offset at 60° allowing for six unique orientations for the head component jig 920. However, if the radially smaller piston 550 is rotated 90°, the reception cuts 914 allow for a new set of six unique orientations, 30° offset from the original six, for a total of twelve potential head component jig 920 orientations.

The jig head capture area 910 of the radially smaller piston 550 may not be the only place a user or designer wishes to attach a jig component. In the event that multiple head components are desired in a condensed location or a bridge between two fixtures 300 may wish to be established, it may be desirable to attach a component to the body of any piston 500. In such a case, specific features may be added to the piston components to make body attachments easier, or body type attachments may be made to interact with the existing vertical and radial relief cutouts 512 and 514.

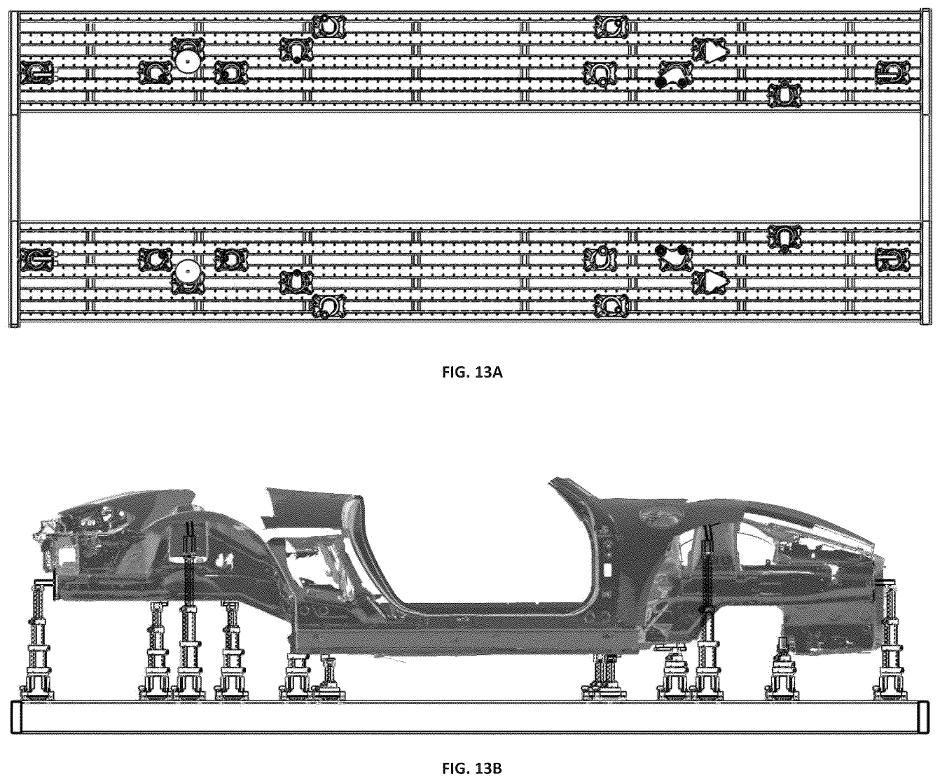

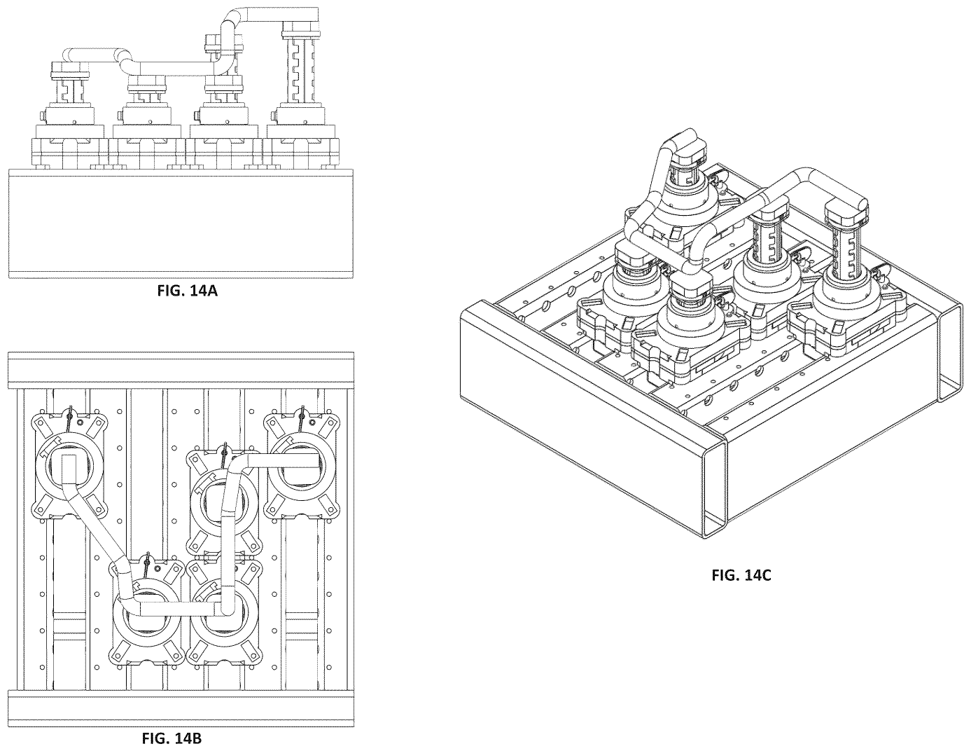

When utilized as a system, multiple variable height telescoping and indexing fixtures 300 setup in a predefined manner, and attached to a datum plane such as a bench with the proper guide and mounting rails, can be utilized to securely position jig heads and mounting positions in exact locations such that an end user may manufacture, measure, inspect, test and or repair any desired workpiece, ranging from the extremely complex geometry of an automobile to a simple bent pipe, and everything in between. This full system utilization can be seen in FIGS. 13A and 13B, as well as FIGS. 14A, 14B, and 14C.

According to one aspect, the required manipulations to adjust the jig system may be completed using automation and robotics.

Within the present disclosure, use of the construct “A and/or B” may mean “A or B or A and B” and may alternatively be expressed as “A, B, or a combination thereof” or “A, B, or both”. Within the present disclosure, use of the construct “A, B, and/or C” may mean “A or B or C, or any combination thereof” and may alternatively be expressed as “A, B, C, or any combination thereof”.

One or more of the components, steps, features and/or functions illustrated herein may be rearranged and/or combined into a single component, step, feature, or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of:” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

While certain exemplary aspects have been described and shown in the accompanying drawings, it is to be understood that such aspects are merely illustrative of and not restrictive on the broad disclosure, and that this disclosure is not be limited to the specific constructions and arrangements shown and described, since various other modifications may occur to those ordinarily skilled in the art.

1. A variable height telescoping and indexed fixturing system, comprising:
a base having a top base end and an opposing bottom base end, the base comprising:
a collar capture section having one or more external relief cutouts;
a connecting mechanism; and
a main base body integrally connected between the collar capture area and the connecting mechanism; and
an aperture located within the top base end having an outer aperture wall and an inner aperture wall;
a telescoping piston having one or more axial cutouts along an external piston wall and capable of axial relative movement within the aperture, where the aperture configured to restrict the piston to sliding axially up and down;
a rotating lock collar having one or more mating extrusions, where the one or more mating extrusions are configured to be received in the one or more external relief cutouts of the collar capture section; and
a handle connected to the rotating lock collar.

2. The system of claim 1, wherein the inner aperture wall includes one or more material extrusions extending outward; and wherein the one or more material extrusions are adapted to be received in the one or more axial cutouts of the piston preventing rotation of the piston.

3. The system of claim 1, further comprising a fixture table, having one or more cutout tracks, forming a datum plane.

4. The system of claim 3, wherein the base is slideably secured in a cutout track in the one or more cutout tracks, and where the base slides parallel to the fixture table.

5. The system of claim 4, wherein the connecting mechanism comprises an upper portion integrally connected to a lower portion, where the lower portion is secured in the cutout track of the one or more cutout tracks.

6. The system of claim 5, further comprising one or more extending locks are located in the lower portion of the connecting mechanism and configured to engage with the fixture table below the datum plane.

7. The system of claim 3, further comprising a digital display located within the base for displaying a height of the telescoping piston from the datum plane.

8. The system of claim 1, wherein the base and the piston are capable of axial relative movement.

9. The system of claim 1, further comprising a single turn locking mechanism for engaging four expanding lock pins and four location lock pins between base and fixture table.

10. The system of claim 9, wherein the single turn locking mechanism engages the base to the fixture table for secure engagement, and wherein the signal turn locking mechanism lacks threaded components.

11. A variable height telescoping and indexed fixturing system, comprising:
a base having a top base end and an opposing bottom base end, the base comprising:
a collar capture section having one or more external relief cutouts;
a connecting mechanism; and
a main base body integrally connected between the collar capture area and the connecting mechanism; and
an aperture located within the top base end having an outer aperture wall and an inner aperture wall;
a telescoping piston having one or more axial cutouts along an external piston wall and capable of axial relative movement within the aperture, where the aperture configured to restrict the piston to sliding axially up and down;
a rotating lock collar having one or more mating extrusions, where the one or more mating extrusions are configured to be received in the one or more external relief cutouts of the collar capture section; and
a handle connected to the rotating lock collar; and
wherein the connecting mechanism comprises an upper portion integrally connected to a lower portion, where the lower portion is secured in the cutout track of the one or more cutout tracks.

12. The system of claim 11, further comprising one or more extending locks are located in the lower portion of the connecting mechanism and configured to engage with the fixture table below the datum plane.

13. The system of claim 11, wherein the inner aperture wall includes one or more material extrusions extending outward; and wherein the one or more material extrusions are adapted to be received in the one or more axial cutouts of the piston preventing rotation of the piston.

14. The system of claim 11, further comprising a fixture table, having one or more cutout tracks, forming a datum plane.

15. The system of claim 13, wherein the base is slideably secured in a cutout track in the one or more cutout tracks, and where the base slides parallel to the fixture table.

16. The system of claim 15, further comprising one or more extending locks are located in the lower portion of the connecting mechanism and configured to engage with the fixture table below the datum plane.

17. The system of claim 13, further comprising a digital display located within the base for displaying a height of the telescoping piston from the datum plane.

18. The system of claim 11, wherein the base and the piston are capable of axial relative movement.

19. The system of claim 11, further comprising a single turn locking mechanism for engaging four expanding lock pins and four location lock pins between base and fixture table.

20. The system of claim 9, wherein the single turn locking mechanism engages the base to the fixture table for secure engagement, and wherein the signal turn locking mechanism lacks threaded components.
